(19) United States
(12) Patent Application Publication
(10) Pub. No.: US 2005/0209881 A1
(43) Pub. Date: Sep. 22, 2005

(54) Method of tracking home-healthcare services

(76) Inventor: Jeffrey W. Norton, Northbrook, IL (US)

Correspondence Address: Jon P. Christensen;Welsh & Katz, Ltd., 22nd Floor, 120 South Riverside Plaza, Chicago, IL, 60606, US

(21) Appl. No.: 10/889,596

(22) Filed: Jul. 12, 2004

Related U.S. Application Data
(60) Provisional application No. 60/555,266, filed on Mar. 22, 2004.

(51) Int. Cl. G06F 17/60

(52) U.S. Cl. 705/2

(57) ABSTRACT

A method and apparatus are provided for collecting information by an organization on home health-care provided to a plurality of care recipients by a plurality of caregivers. The method includes the steps of accepting a call through a call connection by an interactive voice response unit from a caregiver of the plurality of caregivers during a home health-care visit to a care recipient of the plurality of care recipients and determining an identity of the care recipient of the plurality of care recipients by the interactive voice response unit from information associated with the accepted call. The method further includes the steps of recognizing an identity of the caregiver by the interactive voice response unit from information transferred through the call connection and determining a type of care given by the caregiver to the care recipient by the interactive voice response unit from information provided by the caregiver through the call connection.

This application is a continuation of Provisional Application No. 60/555,266 filed Mar. 22, 2004.

### FIELD OF THE INVENTION

The field of the invention relates to healthcare and more particularly to home healthcare.

### BACKGROUND OF THE INVENTION

Home healthcare is a rapidly developing area of the health industry. According to the U.S. Department of Health and Human Services, 88% of discharges now result in a patient's entry into a home healthcare setting. The rational of many states for this shift is that people want to remain in their own homes rather than enter institutions, that the quality of care at home is better than in a nursing home or other institution and the belief that these services will save money.

In some cases, state-run programs have been developed to control the costs of home healthcare programs. While these programs have been successful to some extent, there is a need to develop and expand these programs while at the same time providing mechanisms for controlling fraud and abuse as society and state healthcare systems begin to effectively deal with long-term home-based healthcare in place of institutional care in hospitals and nursing homes. According to the General Accounting Office (GAO) report entitled, State Efforts to Control Improper Payments (2001), “Fear of runaway spending has been a major constraint on service expansion . . . For home health care and personal care services, states controlled expenditures by limits on benefits, low payment rates, and restrictive financial eligibility.” Medicaid spending for Long Term Care in 1997 was $56.1 billion growing to $82.1 billion in 2002. Home Health Care (HHC) is one of the fastest growing segments of this budget. For example, the national HHC budget grew at a faster rate from $13.5 billion in 1997 to $24.7 billion in 2002, an increase of 81% or 13.6% per year.

Estimates of fraud in HHC are as high as 25% of total billing for Medicare and 25% to 30% for Medicaid. Using a 30% fraud rate for Medicare, this would represent $7.4 billion of the overall United States budget based on FY2002 budget figures.

According to the GAO, fraud controls within home healthcare benefit systems are “essentially non-existent”. The GAO asserts that the most common scams are: 1) billing for fictitious visits, 2) billing for unnecessary care, and 3) over billing, such as using lower skill caregivers, but billing for skilled nursing care. Because of the importance of home healthcare, fraud is an issue that must be addressed to ensure the value, credibility and cost effectiveness of Home Healthcare Medicaid programs.

### SUMMARY

A method and apparatus are provided for collecting information by an organization on home health-care provided to a plurality of care recipients by a plurality of caregivers. The method includes the steps of accepting a call through a call connection by an interactive voice response unit from a caregiver of the plurality of caregivers during a home health-care visit to a care recipient of the plurality of care recipients and determining an identity of the care recipient of the plurality of care recipients by the interactive voice response unit from information associated with the accepted call. The method further includes the steps of recognizing an identity of the caregiver by the interactive voice response unit from information transferred through the call connection and determining a type of care given by the caregiver to the care recipient by the interactive voice response unit from information provided by the caregiver through the call connection.

### BRIEF DESCRIPTION OF THE DRAWINGS

FIG. 1 is a block diagram of a system for collecting information on home health-care provided to a plurality of care recipients by a plurality of caregivers under an illustrated embodiment of the invention;

FIG. 2 is a flow chart of claims repair that may be performed by the system of FIG. 1;

FIG. 4 is a screen shot of claims status provided by the system of FIG. 1;

FIG. 5 is a screen shot of claims repair for a missing log-off provided by the system of FIG. 1;

FIG. 6 is a screen shot of claims repair for a recipient not found provided by the system of FIG. 1;

FIG. 7 is a screen voiding a claim provided by the system of FIG. 1;

FIG. 8 is a screen shot of claims repair for an excessively short visit provided by the system of FIG. 1;

FIG. 9 is a screen shot of a claim completion form provided by the system of FIG. 1;

FIG. 10 is a screen that allows a home healthcare provider organization register with the system of FIG. 1;

FIG. 11 is a state selection screen for registration of the home healthcare organization of FIG. 10;

FIG. 12 is a organization registration screen for registration of the home healthcare organization of FIG. 10;

FIG. 13 is a contact registration screen for registration of the home healthcare organization of FIG. 10;

FIG. 14 is a information entry review screen for registration of the home healthcare organization of FIG. 10;

FIG. 15 is a registration acknowledgement screen for registration of the home healthcare organization of FIG. 10;

FIG. 16 is a provider registration screen shot for the home healthcare organization of FIG. 10;

FIG. 17 is a recipient registration screen for the home healthcare organization of FIG. 10;

FIG. 18 is a recipient information screen for the home healthcare organization of FIG. 10;

FIG. 19 is an editable recipient information screen for the home healthcare organization of FIG. 10; and

FIG. 20 is a recipient acceptance screen for the home healthcare organization of FIG. 10.

### DETAILED DESCRIPTION OF AN ILLUSTRATED EMBODIMENT

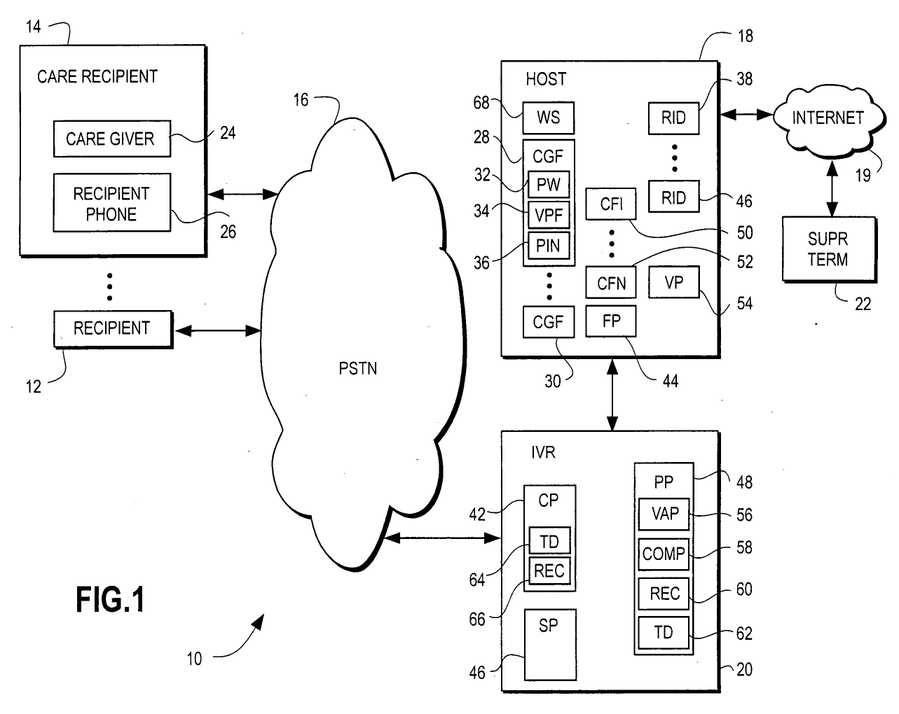

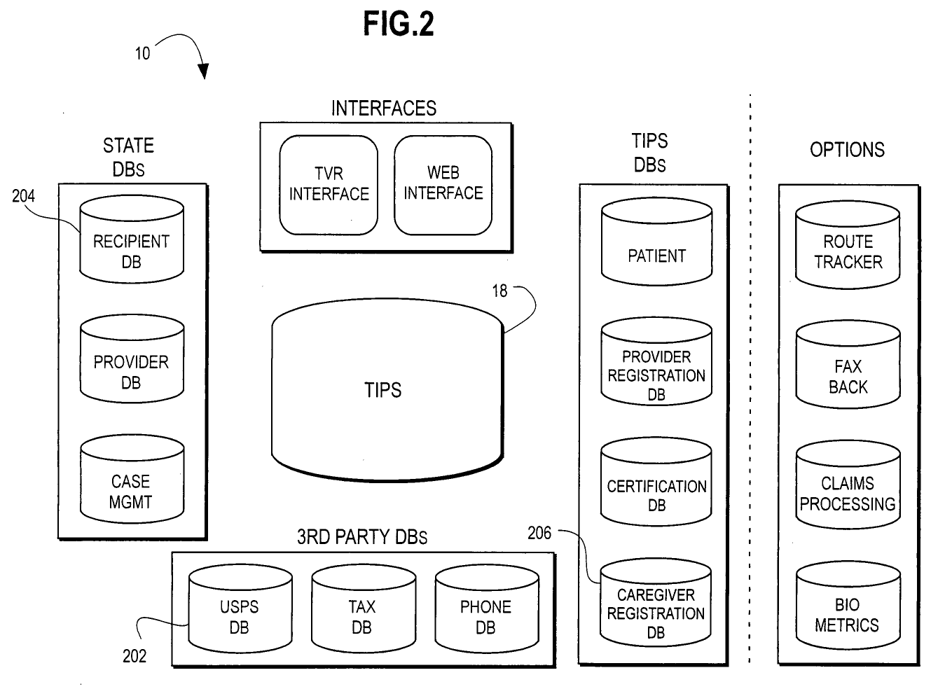

FIG. 1 is a block diagram of a system 10 that may be used by an organization for collecting information on home healthcare provided to healthcare recipients and for submitting claims to a home healthcare guarantor under an illustrated embodiment of the invention. FIG. 2 summarizes a set of databases that may be accessed by the system 10.

The organization that collects the information via use of the system 10 may be the organization that actually provides the healthcare to the healthcare recipients or may be a third-party service provider that uses the system 10 to collect and verify information provided by other home healthcare providers. As used herein, the collection and verification of information provided by home healthcare providers means collecting data from the healthcare provider in real-time while the healthcare provider is in the home of the healthcare recipient providing healthcare to the healthcare recipient. It does not mean receiving healthcare information from some other healthcare providing organization and processing that information.

As shown in FIG. 1, the system 10 may include an interactive voice response unit (IVR) 20 coupled to a host 18 that receives information from healthcare providers 24 within the homes of healthcare recipients 12, 14 through the public switched telephone network (PSTN) 16. While only two healthcare recipients 12, 14 are shown in FIG. 1, it should be understood that calls from the homes of any number of healthcare recipients 12, 14 may be simultaneously serviced by the system 10.

Under illustrated embodiment of the invention, the system 10 eliminates fraud on several levels. On a first level, the system 10 receives calls from the homes of the healthcare recipients 12, 14 and independently verifies both the location of the source of the call (i.e., the identity of the care recipient) and also the identity of the healthcare provider that placed the call.

Independently and concurrently verifying both the identity of the care recipient and the healthcare provider allows the caregiver to positively register their actual presence in the home of the care recipient and ensure that for each claim, there is a basis, in fact, for the claim. It also eliminates any problems of correlating the claim among the recipient, the provider and the time period of the claim.

On another level, the system 10 requires the healthcare provider 24 to identify the type of care given and/or further care needed by the recipient at the time of the call. By requiring the caregiver 24 to identify the type of care given, the system 10 is a position to identify duplication of efforts and to identify care given outside time frames prescribed by a physician or other healthcare professional.

On another level, the system 10 requires the healthcare provider 24 to periodically re-register their presence at the home of the care recipient 12, 14 when the time period required to provide the healthcare exceeds certain time limits. By requiring registration and periodic re-registration, the system 10 can more effectively gauge the effectiveness of the care giving and the payment associated therewith.

On still another level, the requirement for registration, re-registration and for reporting the scope of care given further allows the system 10 to identify problematic caregivers. The identification of problematic caregivers 24 allows such caregivers to be retrained or eliminated. The retraining or elimination of problematic caregivers 24 reduces the overall cost of caregiving even in the absence of fraud.

Turning now to the specifics of the system 10, an explanation will be provided of how the system 10 collects and verifies information on care giving. As a first step, it will be assumed that caregivers 24 and care recipients 12, 14 have been properly registered with the system 10 along with the type of care needed by each care recipient 12, 14. Examples of methods of registering caregivers 24 and recipients 12, 14 will be provided later.

Proper registration within the system 10 by a caregiver 24 means that the system 10 contains a verification file 28, 30 that allows the system 10 to unambiguously identify each caregiver 24. Each verification file 28, 30 may contain a personal identification number (PIN) 36, a password 32 and a voice print file 34.

Contained within each voice print file 34 may be a voice print of each respective caregiver 24. As used herein, a voice print refers to the timing (i.e., the temporal spacing between successive phonemes) of a predetermined sequence of phonemes spoken by a caregiver 24. Verification of the identity of a caregiver means the comparison of the timing of the spoken phonemes from a current registration session with the timing of an identical sequence of phonemes contained within the file 34 where the sequence of phonemes within the file 34 were collected from the caregiver 24 during an original registration of the caregiver 24 with the system 10.

To provide care to a care recipient, a caregiver 24 travels to the home 12, 14 of the care recipient and places a telephone call to the system 10 to register their presence at the home of the recipient 12, 14. The registration of the caregiver's presence at the home of the care recipient 12, 14 causes the system 10 to open a claim file 38, 40 and a related session file 50, 52. The session file 50, 52 is used to collect information related to the claim. The information from the session file 50, 52 may be supplemented by additional information (as described below) thereby becoming the claim file 38, 40.

Once the claim file 38, 40 has been properly completed (as described in more detail below), the claim file 38, 40 defines a health care claim (service claim form) that is, in turn, submitted to a healthcare claim guarantor for payment. Also as used herein, a home healthcare guarantor is a funding source (e.g., Medicare provider, Medicaid provider, private insurer, etc.) that provides funding for home healthcare so long as the home healthcare is provided according to a predefined set of standards defined by the diagnosis of a health professional. As used herein, a service claims document is a claim to the home healthcare guarantor that conforms to a predefined set of information standards regarding the care given and that requests payment for the care given in accordance with the predefined set of standards.

To register their presence at the home of the care recipient 21, 14, the caregiver 24 may place a call from the care recipient's telephone 26 to the IVR 20 of the system 10. The IVR 20 may accept the call from the telephone of the care recipient 26 and use information conveyed by the call in a claim building process that ultimately results in the completion of the health care claim and submission of the claim to the healthcare claim guarantor.

In this regard, once the call is received by the IVR 20, a call processor 42 within the IVR 20 may collect call associated information delivered along with the call and transfer that information to a file processor 44 within the host 18. Call associated information in this context may be Automatic Number Identification (ANI) information received from the PSTN 16. The ANI information may be used by the system 10 to unambiguously identify the call as originating from the telephone of a particular care recipient 12, 14.

Once the call has been accepted by the call processor 42, a script processor 46 may verbally prompt the caregiver 24. In this regard, after greeting the caregiver 24, the script processor 46 may request that the caregiver 24 enter his/her PIN number. The caregiver 24 may respond by entering his/her PIN number using the keypad on the care recipients telephone 26.

A tone processor 48 within the IVR 20 may recognize the entered PIN number. Upon detecting the proper number of digits (or activation of the pound key), the tone processor 48 may transfer the entered PIN number to a file processor 44 within the host 18.

Upon receiving the call associated information and PIN number the file processor 44 may attempt to correlate the call with an existing open claim or, if none are found, to open a new claim. The file processor 44 may correlate the call using the call associated information, the PIN number of the caregiver 24 or both.

The file processor 44 may also identify a caregiver file 28, 30 using the entered PIN number. Upon identification of the caregiver file 28, 30, the file processor 44 may transfer the identified caregiver file 28, 30 to the IVR 20.

Upon receipt of the caregiver file 28, 30, the script processor 46 may verbally prompt the caregiver 24 to utter an identifying sequence of syllables (e.g., state his/her first and last name). A phoneme processor 48 within the IVR 20 may capture the syllables uttered, recognize the phonemes that make up the syllables and measure a time between each phoneme of each uttered syllable.

Within the phoneme processor 48 a voice application processor 56 may sample the syllables and recognize the phonemes that make up the syllables. Once the phonemes are detected, the temporal spacing between the phonemes may also be measured.

It has been found that in the case of certain sequences of phonemes (e.g., names), the temporal spacing between phonemes is repeatable and unique to the speaker. For example, the recitation of the name “John Jones” is unique to each individual. By recognizing the phonemes that make up each caregiver's name and measuring the temporal spacing between each uttered phoneme of each name, a unique voice print of each caregiver 24 can be captured and stored in each caregiver file 34.

To allow access to the system 10, a voice print of each caregiver 24 is captured when that caregiver 24 first applies to give care to the care recipients 12, 14 through the system 10. Each time the caregiver 24 goes to the home of a care recipient 12, 14 and calls into the system 10, a new voice print is captured and compared within a comparator 58 with the voice print on file. The use of voice prints allows caregivers 24 to be unambiguously identified during each care session.

In general, when the caregiver 24 logs-in from a recipient's home 12, 14, the log-in informs the system 10 of the start time of the visit, the identity of the recipient 12, 14 receiving the care (via ANI information) and the identity of the caregiver 24 providing the care (via the PIN number and voice print). A practical example of a log-in may proceed as follows.

The caller may dial into the system 10 by dialing a predetermined telephone number (e.g., 1-866-352-8477). The IVR 20 accepts the call and if the call processor 42 recognizes the call, then control of the call may be passed from a care recipient recognition application (e.g., within the call processor 42) to a caregiver recognition application (e.g., within the phoneme processor 48). In this case, the caregiver recognition application may instruct the script processor 46 to prompts the caregiver 24 by audibly reciting the words “Please enter your PIN followed by the pound key”. Using the telephone touchpad the caregiver 24 enters their PIN and activates the pound key. A tone detector 62 may detect the entered PIN.

The script processor 46 then prompts the caregiver 24 with the words “Please enter your password followed by the pound key”. Using the telephone touchpad, the caregiver 24 enters their numeric password followed by the pound key for detection by the tone detector 62. The script processor 46 then prompts the caregiver 24 with the words “After the tone, please speak your first and last name into the telephone followed by the pound key”. The caregiver 24 responds by speaking their first and last name into the telephone followed by activation of the pound key.

The first and last name may be recorded within a recorder 60 for later reference. As described above, the voice application processor 56 creates a session voice print from the received first and last name and retrieves a reference voice print identified by the PIN number from the respective caregivers file 28, 30. The session voice print may be compared with the reference voice print within the comparator 58. Indication of a match or no match along with the recording of the name may be transferred to the file processor 44 for inclusion in the session file 50, 52.

If the call processor 42 did not recognize the care recipient's telephone number, then the call processor 42 will instruct the script processor 46 to ask for entry of an identifying number of the care recipient 12, 14 (e.g., the care recipient's Medicaid number). In this case, the script processor 46 may prompt the caregiver 24 with the words “The recipient is not known. Please enter the recipient's complete Medicaid number followed by the pound key”.

If the caregiver 24 is not prepared for this question and does not have the recipient's Medicaid number in front of them, then the caregiver 24 may hang up the telephone number, get the Medicaid number and then recall the system 10. In this case, the caregiver 24 will start over from the beginning of the log-in process. Following the prompt to enter the care recipient's Medicaid number, the caregiver 24 will enter the care recipient's Medicaid number followed by the pound key.

The recipient's Medicaid number may be recognized by a tone detector 64 and transferred to the file processor 44. The file processor 44 may send a query to a state recipient database 204 to verify the number.

If the system 10 does not recognize the entered Medicaid number, either because it is not in the database 204 or it was entered incorrectly, then the system 10 will ask for the Medicaid number to be entered again. In this case, the script processor 46 will prompt the caregiver 24 with the words “The recipient is not known. Please enter the recipient's complete Medicaid number followed by the pound key”. Using the telephone touchpad, the caregiver 24 enters the recipient's Medicaid number followed by the pound key.

If after the second entry, the system 10 still cannot find the Medicaid number, then the system 10 will request that the caregiver 24 speak the information requested into the telephone for recording by the IVR 20. In this case, the call processor 42 will instruct the script processor 46 to prompt the caregiuver 24 with the words “The recipient is still not known. After the tone, please speak the recipient's full name and Medicaid number and address into the telephone followed by the pound key”. The caregiver 24 then speaks the first and last name of the care recipient 12, 14, the recipient's address, and the recipient's Medicaid number into the telephone followed by activation of the pound key.

Following the tone, the call processor 42 may activate a recorder 66 to record the recipient's information. A copy of the voice recording may be transferred to the file processor 44 where the information is added to the session file 50, 52.

Anytime during the recording of this message (and before the caregiver presses the pound key), the caregiver may review/rerecord/delete the recording. The caregiver may do so using the following telephone function keys: 1) activation of “2” allows the caregiver 24 to rerecord the message following the prompt “speak after the tone”; 2) activation of “3” allows the caregiver 24 to review his/her recorded message and 3) activation of “4” allows the caregiver 24 to delete the message. The recorded message is added to the appropriate session file 50, 52 along with the time of log-in.

Once the recorded message is complete or if the system 10 did, in fact, recognize the care recipient's telephone number (base upon ANI information or the entered identifying number), the script processor 46 prompts the caregiver 24 with the words “You have been successfully logged-in”. The caregiver 24 may then hang up.

Base upon local requirements (e.g., state Medicaid requirements), caregivers 24 may be required to make “Continuation of Care” calls after some predetermined period of elapsed time (e.g., one per hour). In this case, the caregiver 24 may dial the predetermined telephone number (e.g., 1-866-352-8477). The script processor 46 may prompt the caregiver 24 with the words “Welcome to the caregiver's system. Please enter your PIN followed by the pound key”. Using the telephone touchpad, the caregiver 24 enters their PIN and activates the pound key. The script processor 46 then prompts the caregiver 24 with the words “Please enter your password followed by the pound key”. Using the telephone number touchpad, the caregiver 24 enters their numeric password and activate the pound key.

Using the information received from the call connection, the file processor 44 identifies this call as being associated with an open session file and transfers notification of the open file back to the script processor 46. This causes the script processor 46 to prompt the caregiver 24 with the words “Please press two if you are continuing your visit or press three if you are logging-out”. In response, the caregiver 24 may activate the “2” key. The script processor 46 then prompts the caregiver 24 with the words “You have extended your visit”. The caregiver 24 may then hang up.

When a caregiver 24 calls the system 10 and logs-out of a home healthcare visit, the log-out causes the file processor 44 to enter a log-out time into the session file 50, 52 and a total time of the visit. In addition to logging-out of a visit, the caregiver 24 can record information specific to the visit including services performed, supplies used, health related concerns and reminders for future visits. There is also the option to leave a message for program suggestions.

To log-out, the caregiver 24 may call into the system at the predetermined telephone number (e.g., 1-866-352-8477). The script processor 46 prompts the caregiver 24 with the words “Welcome to the caregiver's system. Please enter your PIN followed by the pound key”. Using the telephone touchpad, the caregiver 24 enters their PIN and activates the pound key. The script processor 46 then prompts the caregiver 24 with the words “Please enter your password followed by the pound key”. Using the telephone touchpad, the caregiver 24 enters their PIN and activates the pound key.

Using the information from the call, the file processor 44 identifies this call as being associated with an open claim and notifies the script processor 46 accordingly. The script processor 46, in response, prompts the caregiver 24 with the words “Please press two if you are continuing your visit or press three if your are logging out”. The caregiver 24 may press the “3” key. In response, the script processor 46 may prompt the caregiver 24 with the words “After the tone, please speak your first and last name into the telephone followed by the pound key”. The caregiver 24 may then speak his/her first and last name and activate the pound key. The script processor 46 may then prompt the caregiver 24 with the words “After the tone, speak your service information into the telephone followed by the pound key”. The caregiver 24 may then speak any or all of their home health visit service information into the telephone and then activate the pound key. The script processor 46 may then prompt the caregiver 24 with the words “After the tone, either hang up to end this call or make a suggestion followed by the pound key”.

If there aren't any suggestions, then the caregiver 24 simply hangs up the telephone. If there are suggestions, the caregiver 24 explains the suggestions into the telephone, activates the pound key and hangs up. In either case, the recording(s) are added to the respective claim form.

Upon logging-off with respect to a care recipient 12, 14, the system 10 may compose a home healthcare claim and forward the claim to a healthcare claim guarantor for payment. Alternatively, the information within a session file 50, 52 may not be complete or may need to be corrected. In this regard, a supervisor or administrator working through a supervisors terminal 22 may access the claims through the Internet 19 to review and correct (repair) the claims 50, 52. As used herein, repairing a claim means correcting any errors that would otherwise prevent the claim from being accepted by a healthcare insurer (e.g., Medicaid, Medicare, private insurer, etc.).

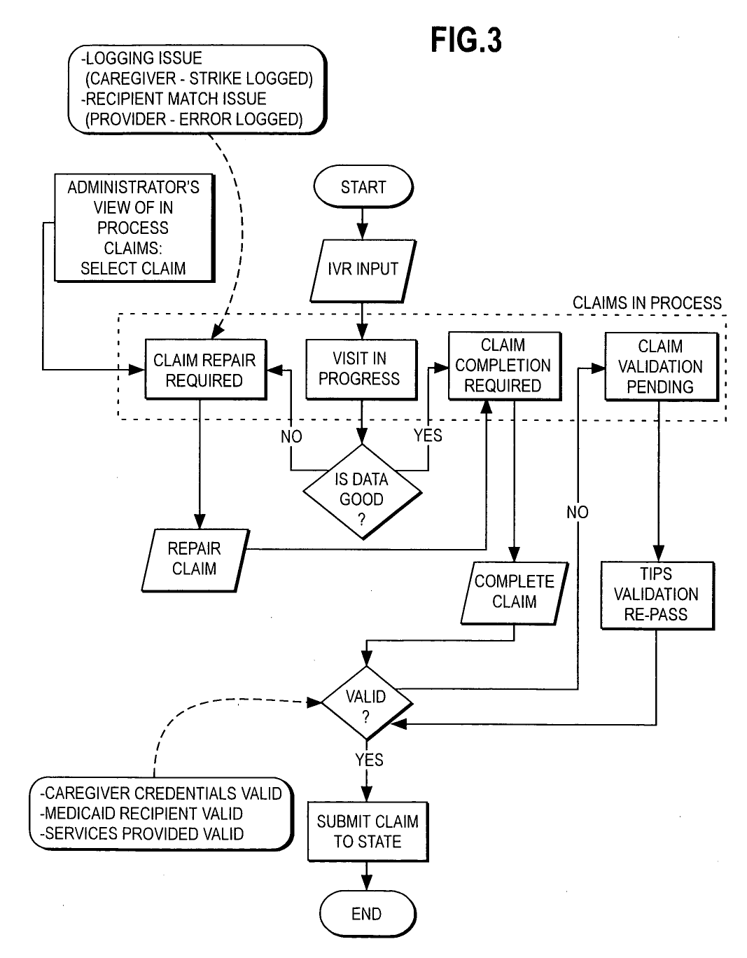

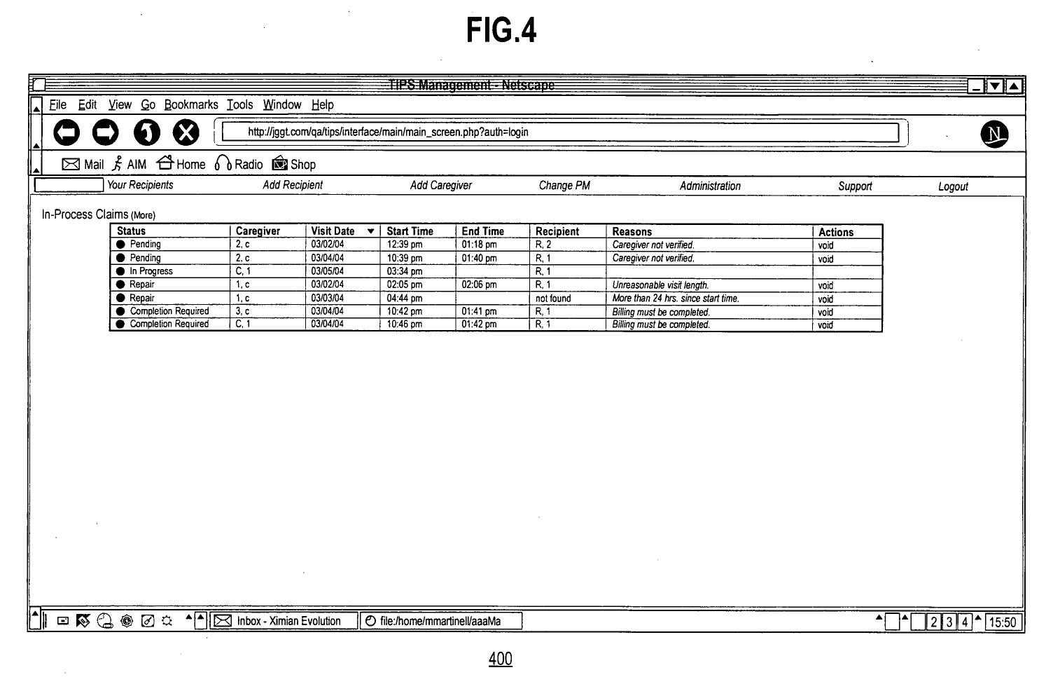

Repair and completion of the claims 50, 52 may occur substantially as shown in FIG. 2. FIG. 4 depicts a main screen 400 for claim repair that may be downloaded to the supervisor or administrator terminal 22 to initiate this process.

FIG. 4 shows seven in-process claims. There in-process claims can assume any of four possible states identified by the file processor 44. The first state is an “in progress” state. These claims are incomplete in that they only have a log-in call from a caregiver 24. Claims in this state provide a real-time view of a visit in progress. The supervisor may only view these claims. No editing may be done by the supervisor until the log-out event occurs or until 24 hours have passed since the log-in event. This type of claim appears in the color blue on the screen 400 of FIG. 4.

In the second state, claim repair is required. Claims that fall unto this state are claims where a visit has occurred but where there is a problem with the data due to logging in or out by the caregiver 24 or with the set up information of the care recipient 12, 14 within the system 10. This type of in-process claim line item appears on the screen 400 in the color red.

In the third state, claim completion is required. Claims are classified into the third state by the file processor 44 when the information received through the IVR 20 and the care recipient's identifying information is correct, but the care recipient's claim information (e.g., CPT codes, DRG codes) are incomplete. Claims in this state appear on the screen 400 in the color green.

The fourth state is where a claim is complete (i.e., pending). Claims enter this state where all the claims information has been entered into the system 10 by the supervisor, but the claim cannot be submitted to the claims guarantor due to a validation problem (e.g., skill level of caregiver cannot be verified, unreasonable visit length, etc.).

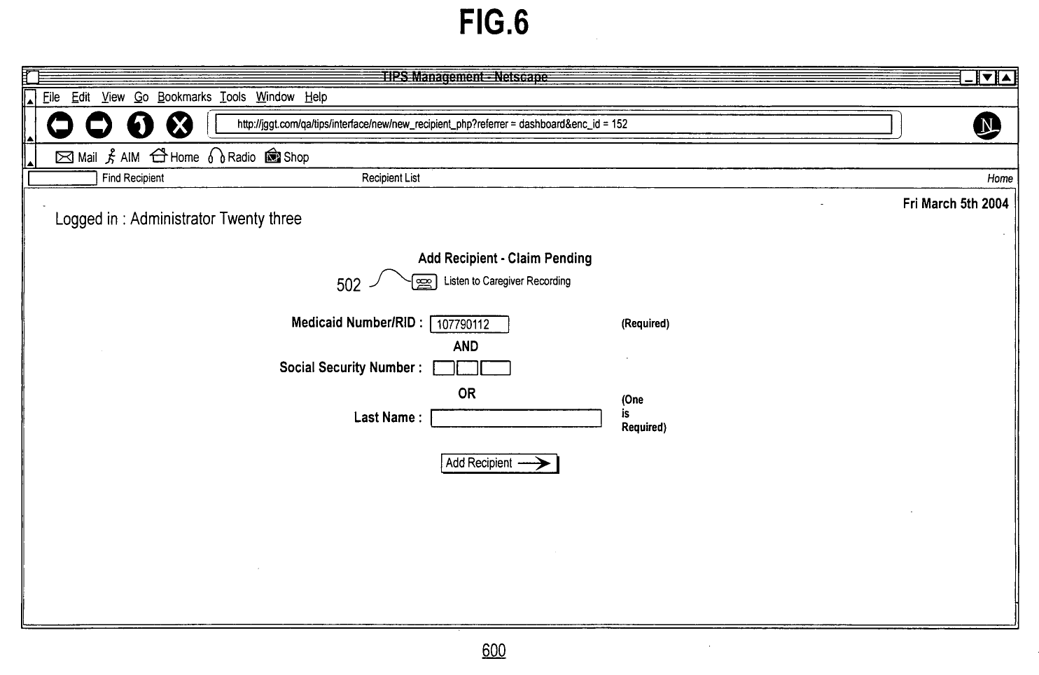

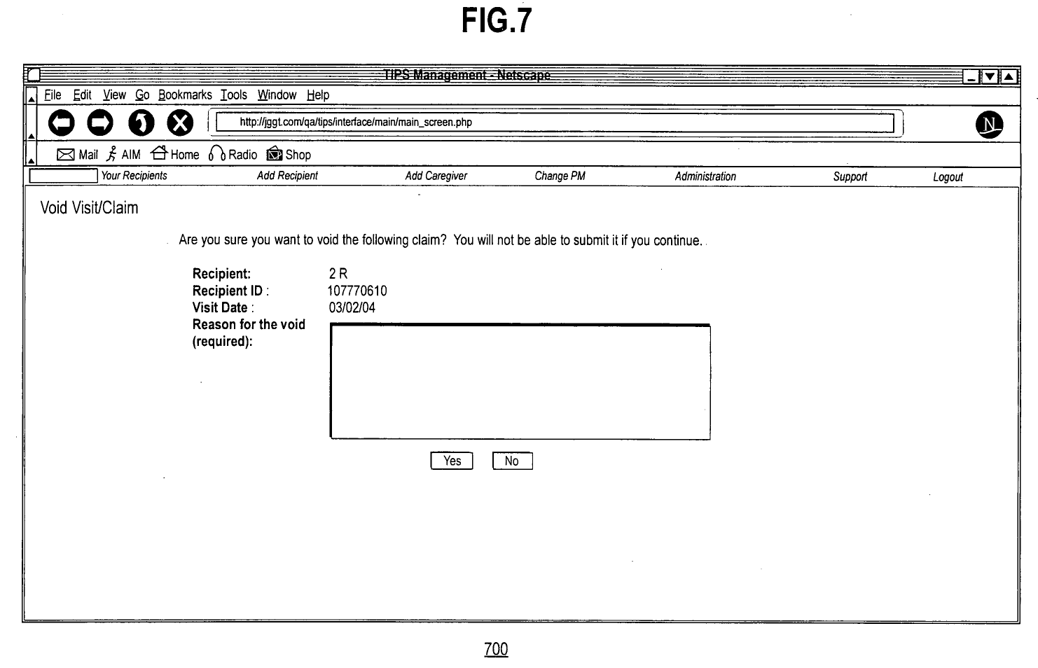

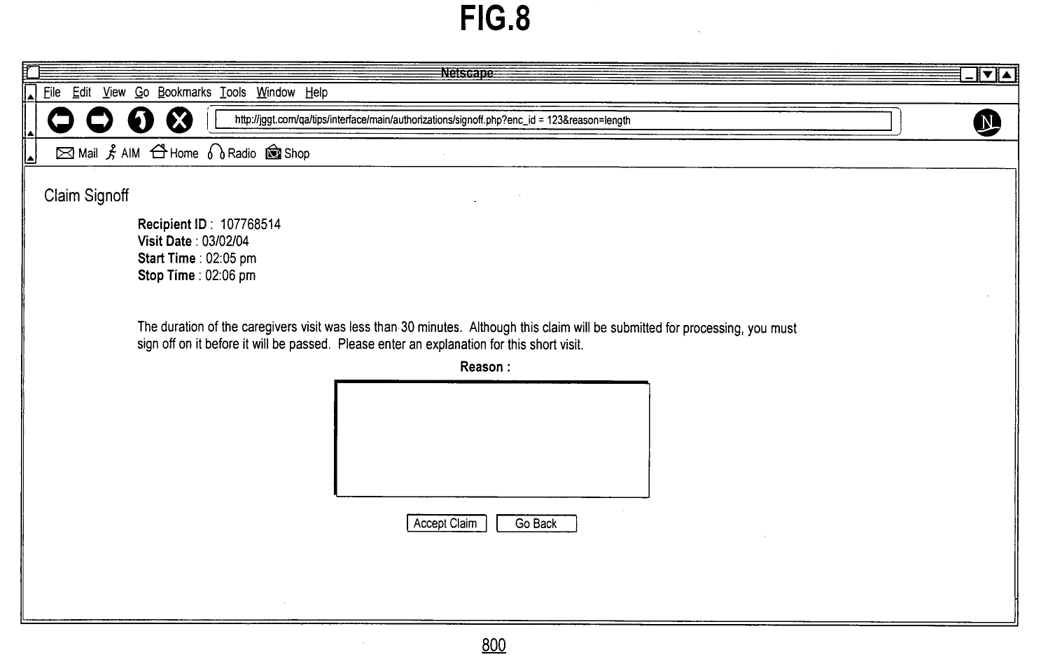

In the “Reason” column of the screen 400, the supervisor may find the reason for the claim status. In the case of Repair, the reasons are listed one at a time. The supervisor selects the claim to be repaired and the file processor 44 takes the supervisor to the screen (FIGS. 4-6) where the current fix/explanation needs to be completed. In effect, the listed reason in the “Reason” column provides a hyperlink to the repair screen for the selected file.

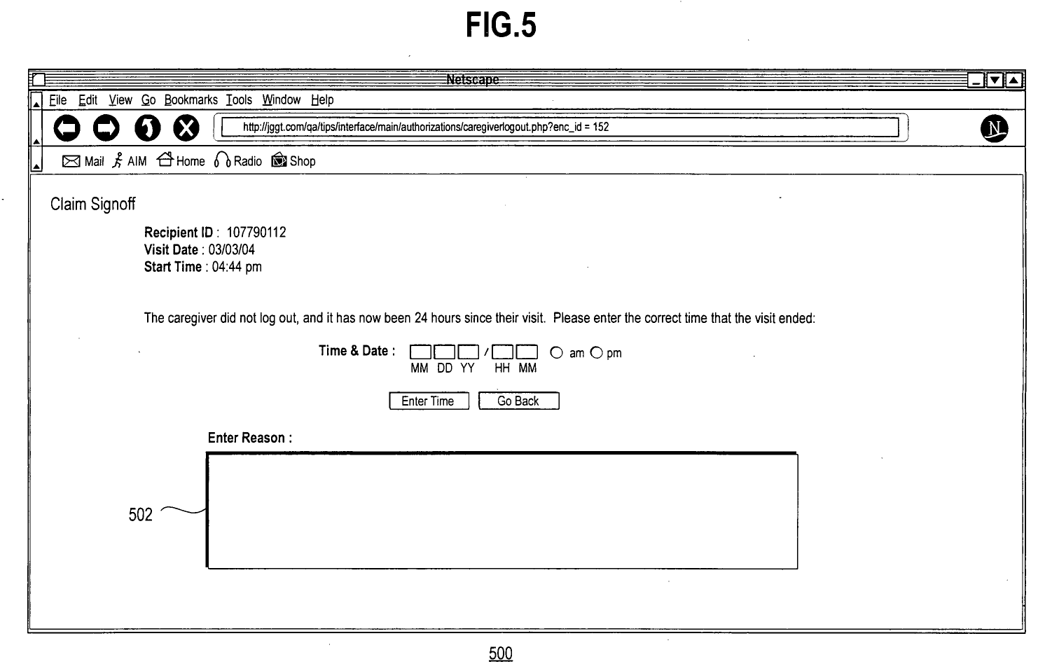

Using the appropriate screen, the supervisor can add or correct any incorrect information (e.g., add a log-out time in the screen 500 of FIG. 5). In each case, the supervisor may be provided with a free-form text explanation box 502 that must be filled out explaining the reason for the change.

If the problem is with caregiver input, the file processor 44 will check the number of “strikes” that the caregiver 24 has and if the number of strikes exceeds a predetermined limit (e.g., 6) within some predetermined time period (e.g., 3 months), then the file processor 44 will not allow the claim to be repaired. Even if the number of strikes does not exceed the limit, the number of strikes will be incremented by one for the associated caregiver.

In the case where a care recipient 12, 14 cannot be identified, the screen 600 may include a link 602 to the recording of the caregiver 24 that was captured during the log-in session (required by the system 10 if a valid Medicaid number cannot be found during the caregiver log-in). The recording may be used to assist the supervisor in correcting invalid care recipient identifiers, phone numbers and addresses. A link 602 may also be provided to the caregivers recorded comments during log-out.

Once a claim has been repaired, its status is changed to “claim completion required”. The supervisor can decide to complete the claim immediately or may save the repairs and chose to complete the claim at a later time.

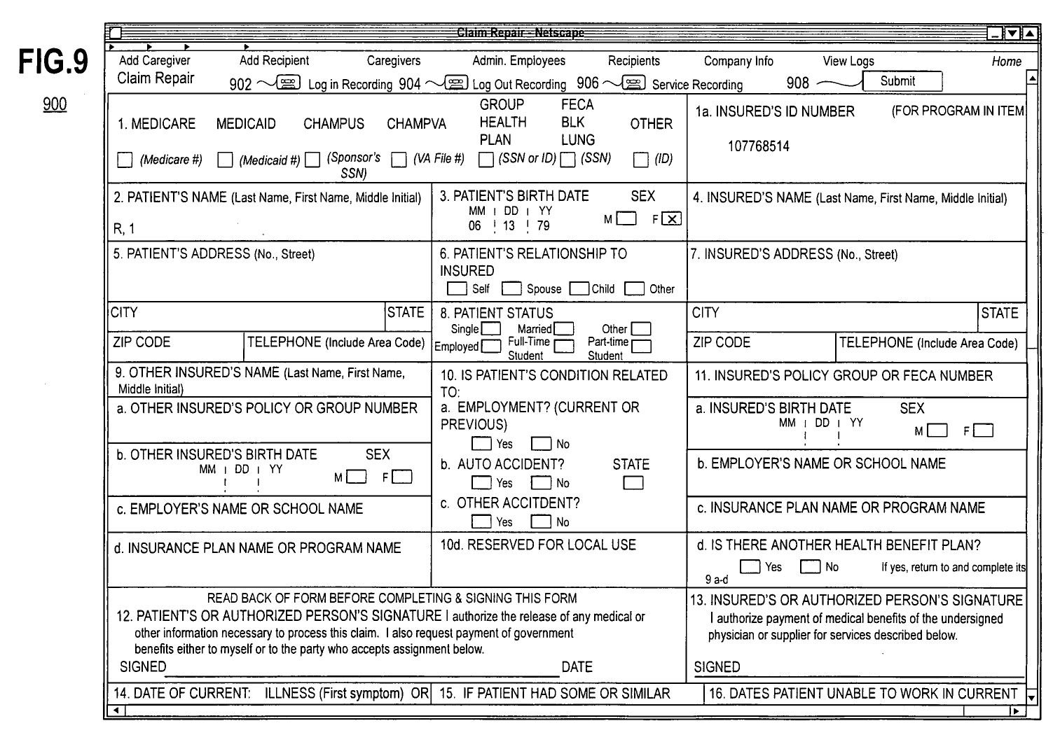

To complete a claim, the supervisor may select a “claim completion required” item from the list of FIG. 4 (i.e., with a green color). In response, the file processor 44 presents a claim completion form 900 (FIG. 9). This editable screen 800 may be pre-populated with information from the visit and with additional required fields to be completed that, in turn, may be shown highlighted.

Upon viewing the screen 900, the supervisor may begin to complete any required items. In this regard, links 902, 904, 906 are provided to the recordings of the caregiver 24 during the visit. The supervisor may listen to the recordings to obtain additional information about the care recipient and the visit. Additional links may be provided to U.S. Postal Service database 202 and care recipient database 204 through which the supervisor can correlate and identify care recipients based upon address, name or any other criteria.

Upon entering any changes, the supervisor may activate a submit button 908 to send the claim 900 to a validation processor 54 for purposes of determining if the claim is in the proper form to be sent to the claim guarantor. Validation checks performed by the validation processor 54 include verification that the voice print from the caregiver's file matched the voice print captured during the visit. Another validation check includes determining that the credentials of the caregiver have been validated for the level of care that is being billed. Another check may be to verify that a Medicaid recipient is listed in the appropriate state database 206. Another check may be that the level of care being billed for is consistent with an approved level of care. Other validation rules may be appropriate to the state in which the care recipient resides.

After receiving the claim, the validation processor 54 may return a screen with a message indicating that the claim has been validated and scheduled to be submitted to the claims guarantor or that there is a validation problem. If there is still a validation problem, the validation processor may return the claim along with information identifying any problems. If the claim has been validated, then the claim is placed into the “claim validation pending” state on the screen 400 outlined in the color yellow.

In another embodiment, the system 10 may be used to validate claims in the situation where a care recipient 12, 14 does not have a phone. In this situation, the caregiver 24 may be allowed to use a cellphone with locating features to perform log-ins, continuations of service and log-outs. As is known, most cell phones build after 1999 have features that allow the location of a cell phone be determined through the cellular infrastructure. While this feature is not as accurate as ANI, the use of cellphone tracking still provides a level of verification that significantly improves upon prior practices.

In this case, the call processor 42 detects cellphone calls based upon a source indicator from the cellular infrastructure. In response, the call processor 42 requests a location indicator from the cellular infrastructure. The location indicator may be stored in the session file 50, 52 as proof of the relative location of the source of the cellular call.

In another embodiment of the invention, the system 10 may be used by a third party service provider to track the activities of caregiver organizations. In this case, registration of the caregiver organizations may be provided through a website 68 on the host 18 accessed via a predetermined web address (e.g., www.tipregister.com).

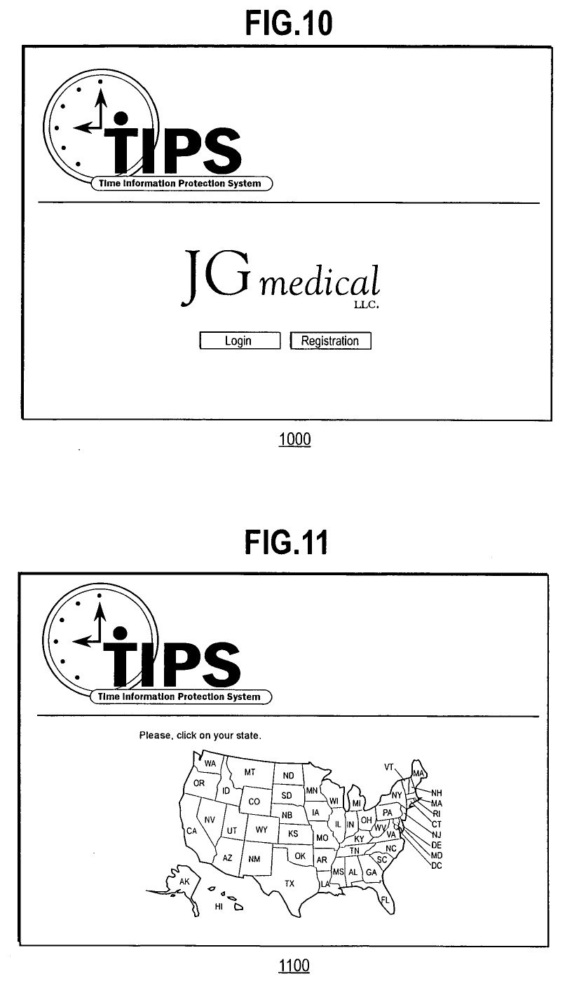

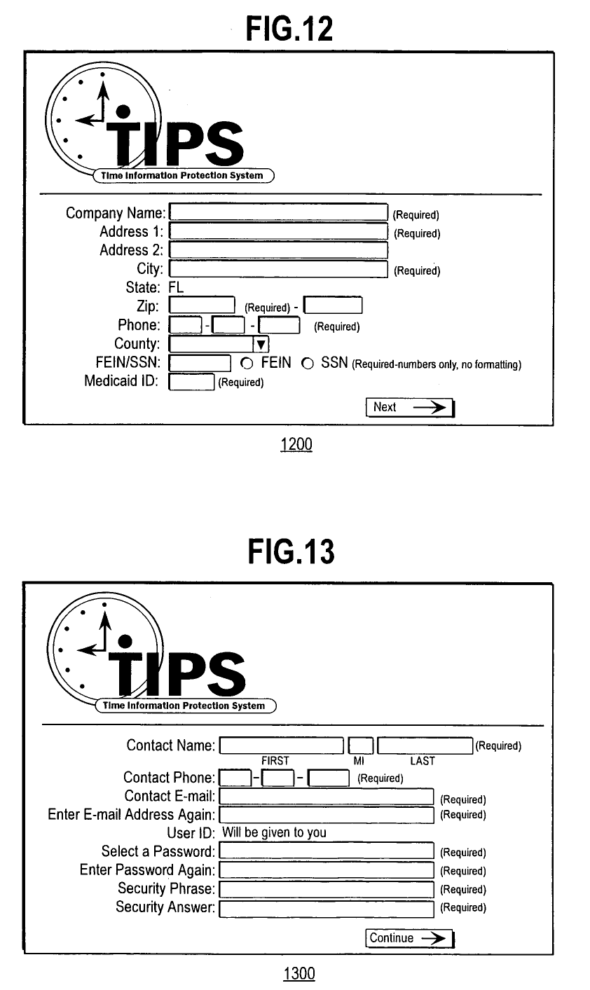

Upon accessing the website 68, a registering caregiver organization may be provided with the registration screen 1000 shown in FIG. 10.

On the registration screen 1000, an administrator may be presented with a “LOGIN” button and a “REGISTRATION” button. The administrator may activate the “REGISTRATION” button and be taken to a second screen 1100 of FIG. 11.

The second screen 1100 allows the administrator to select a state in which the care giver organization will do business. The selection of the state is of importance to the system 10 in that the selection allows the system to incorporate different databases and validity checks into the validity checks based upon state requirements.

The administrator selects a state and is presented with a provider registration screen 1200 (FIG. 2). On the provider registration screen, the administrator is required to enter his/her name and contact information. Also required is a Medicaid ID which is a state issued license number under which the provider submits claims to the Medicaid system. The provider is also required to provide a FEIN/SSN which is a Federal Employer Identification Number or the social security number of the owner.

Upon completion of the screen 1200, the administrator actives NEXT and is presented with a contact information form 1300 (FIG. 13). In addition to name information, the provider is required to enter a phone number, an e-mail address, a password, a security phrase and a security phrase answer. The password must be at least 8 digits long and include at least one alpha and one numeric value.

The security phrase and answer provides a convenient way for representatives of the system 10 to identify the administrator. In general, the security phrase is something easy for the administrator to remember and difficult for someone else to guess.

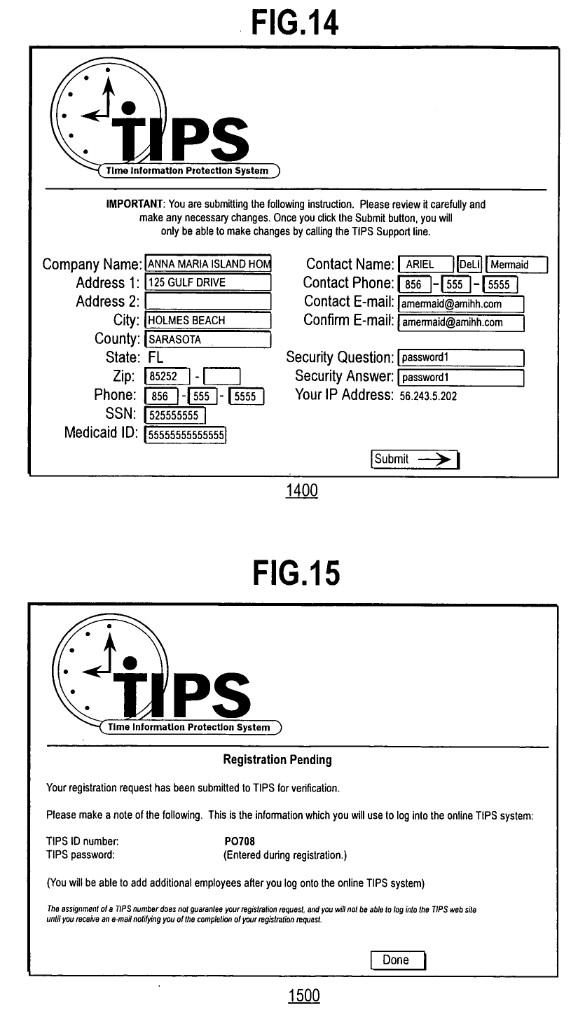

Following completion of the contact information screen 1300, the administrator may activate the CONTINUE button and be provided with a review screen 1400 (FIG. 14). The administrator may review all fields for accuracy and correct any errors. After the screen is determined to be correct, the administrator activates the SUBMIT button and is presented with the REGISTRATION PENDING screen 1500 (FIG. 15).

The REGISTRATION PENDING screen 1500 shows the ID number for the system 10 with a prefix “P”. The administrator may use the ID number along with the password previously entered to edit any information related to caregivers or claims.

Before a caregiver 24 can enroll for access to the system 10, or use the system 10 for a home healthcare visit, an administrator must register the caregiver 24 with the system 10. This is to ensure updated and appropriate credentialing is used for the caregiver 24.

To register a caregiver 24, the administrator accesses a homepage of the website 68 and activates an ADMINISTRATION link. From the ADMINISTRATION page, the administrator selects ADD CAREGIVER.

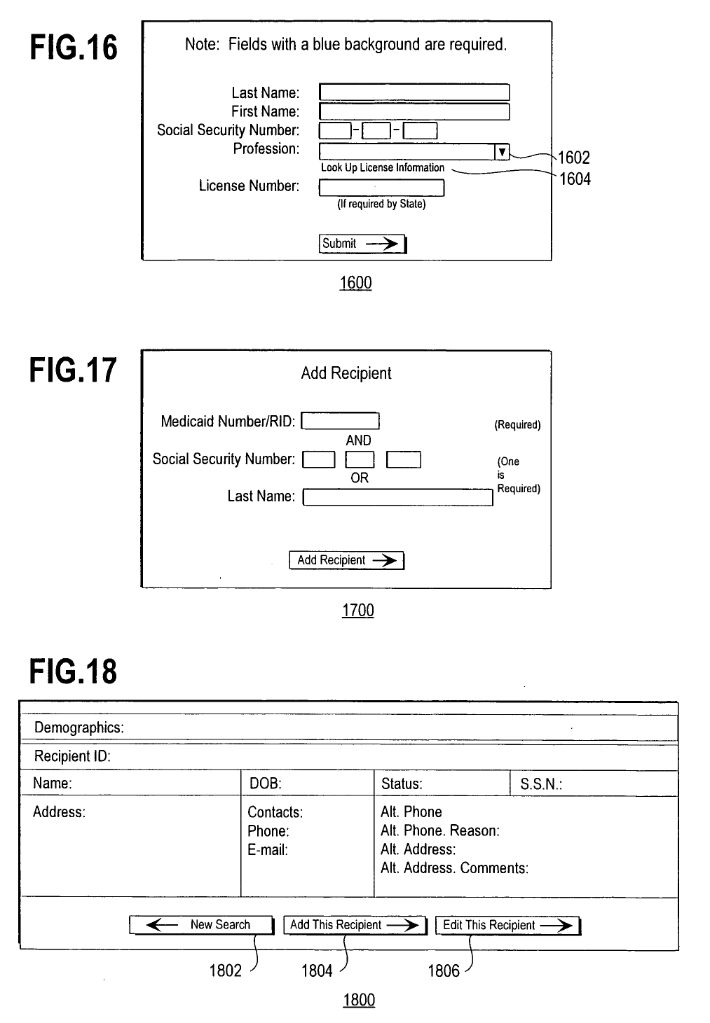

Selection of the ADD CAREGIVER results in the screen 1600 (FIG. 16) being presented to the administrator. Using the ADD CAREGIVER screen 1600, the administrator may enter the name of the appropriate caregiver 24. The profession may be chosen from the drop down menu 1602. Be selecting LOOK UP LICENSE, the administrator may open a browser window to search for the license number of the caregiver 24 being registered in the database 206. Once the data is complete, the administrator may activate the SUBMIT button.

In addition to registration of caregivers 24, the administrator may also register care recipients 12, 14. To register care recipients 12, 14, the administrator may go to the home page of the web site 68 and select ADD RECIPIENT. Selecting ADD RECIPIENT takes the administrator to the screen 1700 (FIG. 17).

Within the screen 1700, the administrator may enter the Medicaid Number/RID and social security number or last name (one is required). The Medicaid/RID is the care recipient's state issued number. Last name refers to the last name of the recipient and should be entered if the recipient has not been issued a social security number. Following completion of the entry of information, the administrator may select ADD RECIPIENT to continue.

If the recipient's Medicaid number matches a Medicaid number shown in the state's database 204, the screen 1800 (FIG. 18) will be displayed to the administrator. The screen 1800 may be populated with the stat's information for the Medicaid number entered.

If this is not the proper recipient, the administrator may activate the NEW SEARCH button. If the information on the screen 1800 is correct, then the administrator may activate the ADD THIS RECIPIENT button 1804 to add this recipient to the list of active recipients 12, 14 within the system 10.

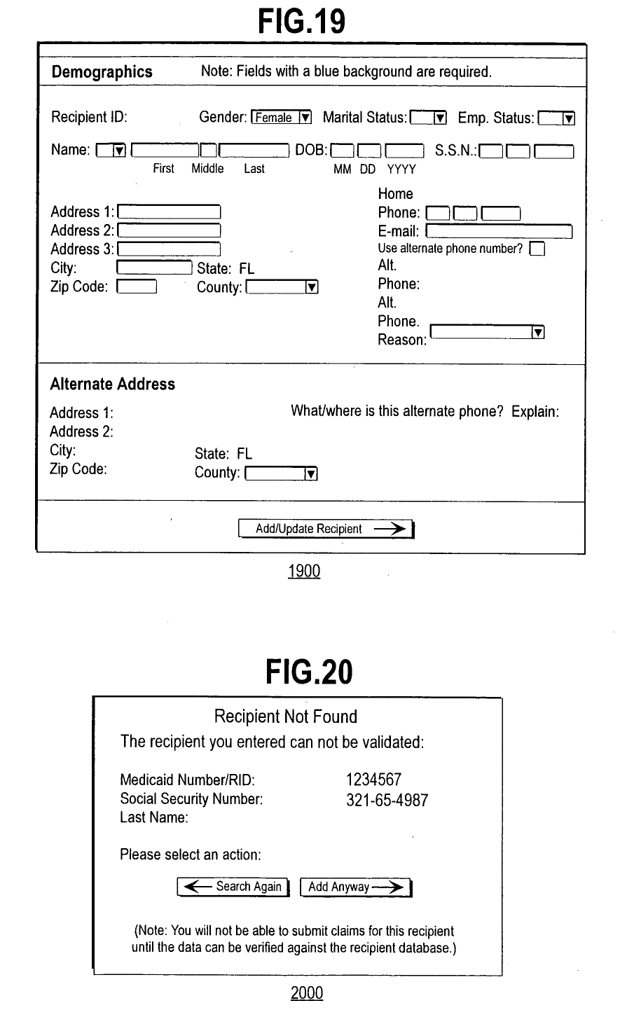

If the administrator has additional alternate information, then the administrator may activate the EDIT THIS RECIPIENT button. Activating the EDIT THIS RECIPIENT will cause the screen 1900 (FIG. 19) to be displayed.

Activation of the EDIT THIS RECIPIENT button 1800 causes the system 10 to search the state's database 204 and to retrieve any other information available from the state. The administrator may accept or edit this information contingent upon state approval for verifiable reason. Any updates or edits to the information may be explained in a pop-up window that will appear when the ADD/UPDATE RECIPIENT is activated to complete this registration.

If part or all of the ADD RECIPIENT information does not match the state Medicaid database 204, then the administrator may receive the RECIPIENT NOT FOUND screen 2000 (FIG. 20). If the administrator should notice that the information is not entered correctly, then the administrator may activate the SEARCH AGAIN button and be taken back to the ADD RECIPIENT screen 1700.

If after review, it appears that all of the information was entered correctly, then there is the possibility that the recipient has a Medicaid number that has not been released into the state database 204. In this case, the administrator may activate the ADD ANYWAY button. This will bring the administrator to the EDIT RECIPIENT screen 1900 where the administrator can enter the recipient information and register them within the database of the system 10 (with verification to be added later).

Once a caregiver 24 is registered with the system 10, the caregiver 24 may enroll in the system 10 through the telephone. Through the enrollment process, the caregiver will create a unique user password and a voice print identification that will be saved in the appropriate caregiver file 28, 30.

A specific embodiment of a method and apparatus for tracking home healthcare has been described for the purpose of illustrating the manner in which the invention is made and used. It should be understood that the implementation of other variations and modifications of the invention and its various aspects will be apparent to one skilled in the art, and that the invention is not limited by the specific embodiments described. Therefore, it is contemplated to cover the present invention and any and all modifications, variations, or equivalents that fall within the true spirit and scope of the basic underlying principles disclosed and claimed herein.

1. A method of collecting information by an organization on home health-care provided to a plurality of care recipients by a plurality of caregivers, such method comprising the steps of:
accepting a call through a call connection by an interactive voice response unit from a caregiver of the plurality of caregivers during a home health-care visit to a care recipient of the plurality of care recipients;
determining an identity of the care recipient of the plurality of care recipients by the interactive voice response unit from information associated with the accepted call;
recognizing an identity of the caregiver by the interactive voice response unit from information transferred through the call connection; and
determining a type of care given by the caregiver to the care recipient by the interactive voice response unit from information provided by the caregiver through the call connection.

2. The method of collecting home health-care information as in claim 1 wherein the determination of the identity of the care recipient further comprises receiving automatic number identification information through the call connection.

3. The method of collecting home health-care information as in claim 1 wherein the determination of the identity of the care recipient further comprises the interactive voice response unit receiving a Medicaid number of the care recipient from the caregiver through the call connection.

4. The method of collecting home health-care information as in claim 1 wherein the determination of the identity of the care recipient further comprises the interactive voice response unit receiving the care recipient's name, address and Medicaid number through the call connection from the caregiver.

5. The method of collecting home health-care information as in claim 1 wherein the step of recognizing the caregiver further comprises detecting a personal identification number of the caregiver entered through a telephone of the care recipient.

6. The method of collecting home health-care information as in claim 5 wherein the step of recognizing the caregiver further comprises the interactive voice response unit requesting the caregiver to recite the caregiver's name.

7. The method of collecting home health-care information as in claim 6 further comprising sampling the caregiver's recitation of the caregiver's name and comparing the sampled recitation with a predefined template of the caregiver's name.

8. The method of collecting home health-care information as in claim 1 further comprising the interactive voice response unit receiving a reason for the call from the caregiver.

9. The method of collecting home health-care information as in claim 8 further comprising defining the reason for the call as being a notification of a starting time of the visit from the caregiver in giving care to the care recipient.

10. The method of collecting home health-care information as in claim 8 further comprising defining the reason for the call as being a notification of continuation of care from the caregiver in giving care to the care recipient notifying the organization that a cumulative time of the visit will exceed a predetermined time limit.

11. The method of collecting home health-care information as in claim 8 further comprising defining the reason for the call as being a log off from the caregiver notifying the organization of an end of the visit.

12. The method of collecting home health-care information as in claim 11 wherein the step of determining a type of care given by the caregiver to the care recipient further comprises the interactive voice response unit receiving service information from the caregiver following the notification of log off by the caregiver.

13. The method of collecting home health-care information as in claim 12 wherein the step of receiving the service information further comprises recording a voice of the caregiver as the caregiver provides the service information.

14. The method of collecting home health-care information as in claim 13 further comprising a host retrieving the service information from the interactive voice response unit and compiling the service information into a healthcare claim.

15. The method of collecting home health-care information as in claim 14 further comprising retrieving and repairing the compiled healthcare claim.

16. The method of collecting home health-care information as in claim 15 wherein the step of repairing the compiled healthcare claim further comprising a supervisor opening the compiled healthcare claim through a terminal and listening to the recorded service information.

17. A apparatus used by an organization for collecting information on home health-care provided to a plurality of care recipients by a plurality of caregivers, such apparatus comprising:
means for accepting a call from a caregiver of the plurality of caregivers during a home health-care visit to a care recipient of the plurality of care recipients;
means for determining an identity of the care recipient of the plurality of care recipients from information associated with the accepted call;
means for recognizing an identity of the caregiver from information transferred through the call connection; and
means for determining a type of care given by the caregiver to the care recipient from information provided by the caregiver through the call connection.

18. The method of collecting home health-care information as in claim 17 wherein the means for determining the identity of the care recipient further comprises means for receiving automatic number identification information through the call connection.

19. The method of collecting home health-care information as in claim 17 wherein means for determining the identity of the care recipient further comprises means within the interactive voice response unit for receiving a Medicaid number of the care recipient from the caregiver through the call connection.

20. The method of collecting home health-care information as in claim 17 wherein the means for determining the identity of the care recipient further comprises means within the interactive voice response unit for receiving the care recipient's name, address and Medicaid number through the call connection from the caregiver.

21. The method of collecting home health-care information as in claim 17 wherein the means for recognizing the caregiver further comprises means for detecting a personal identification number of the caregiver entered through a telephone of the care recipient.

22. The method of collecting home health-care information as in claim 21 wherein the means for recognizing the caregiver further comprises means within the interactive voice response unit for requesting the caregiver to recite the caregiver's name.

23. The method of collecting home health-care information as in claim 22 further comprising means for sampling the caregiver's recitation of the caregiver's name and comparing the sampled recitation with a predefined template of the caregiver's name.

24. The method of collecting home health-care information as in claim 17 further comprising means within the interactive voice response unit for receiving a reason for the call from the caregiver.

25. The method of collecting home health-care information as in claim 24 further comprising defining the reason for the call as being a notification of a starting time of the visit from the caregiver in giving care to the care recipient.

26. The method of collecting home health-care information as in claim 24 further comprising defining the reason for the call as being a notification of continuation of care from the caregiver in giving care to the care recipient notifying the organization that a cumulative time of the visit will exceed a predetermined time limit.

27. The method of collecting home health-care information as in claim 24 further comprising defining the reason for the call as being a log off from the caregiver notifying the organization of an end of the visit.

28. The method of collecting home health-care information as in claim 27 wherein the means for determining a type of care given by the caregiver to the care recipient further comprises means within the interactive voice response unit for receiving service information from the caregiver following the notification of log off by the caregiver.

29. The method of collecting home health-care information as in claim 28 wherein the means for receiving the service information further comprises means for recording a voice of the caregiver as the caregiver provides the service information.

30. The method of collecting home health-care information as in claim 29 further comprising a host retrieving the service information from the interactive voice response unit and compiling the service information into a healthcare claim.

31. The method of collecting home health-care information as in claim 30 further comprising means for retrieving and repairing the compiled healthcare claim.

32. The method of collecting home health-care information as in claim 31 wherein the means for repairing the compiled healthcare claim further comprises a supervisor opening the compiled healthcare claim through a terminal and listening to the recorded service information.

33. A apparatus used by an organization for collecting information on home health-care provided to a plurality of care recipients by a plurality of caregivers, such apparatus comprising:
a call connection that receives a call from a caregiver of the plurality of caregivers during a home health-care visit to a care recipient of the plurality of care recipients;
a call processor that determines an identity of the care recipient of the plurality of care recipients from information associated with the accepted call;
a phoneme processor that recognizes an identity of the caregiver by the interactive voice response unit from information transferred through the call connection; and
a claim file that allows a determination of a type of care given by the caregiver to the care recipient by the interactive voice response unit from information provided by the caregiver through the call connection.

34. The method of collecting home health-care information as in claim 33 wherein the call processor that determines the identity of the care recipient further comprises automatic number identification information delivered through the call connection.

35. The method of collecting home health-care information as in claim 33 wherein the call processor that determines the identity of the care recipient further comprises a Medicaid number of the care recipient received from the caregiver through the call connection.

36. The method of collecting home health-care information as in claim 33 wherein the call processor further comprises an audio recorder that receives the care recipient's name, address and Medicaid number through the call connection from the caregiver.

37. The method of collecting home health-care information as in claim 33 wherein the phoneme processor that recognizes the caregiver further comprises a tone detector that detects a personal identification number of the caregiver entered through a telephone of the care recipient.

38. The method of collecting home health-care information as in claim 37 wherein the phoneme processor that recognizes the caregiver further comprises a script processor within the interactive voice response unit for requesting the caregiver to recite the caregiver's name.

39. The method of collecting home health-care information as in claim 38 further comprising a voice application processor that samples the caregiver's recitation of the caregiver's name and a comparator that compares the sampled recitation with a predefined template of the caregiver's name.

40. The method of collecting home health-care information as in claim 33 further comprising a tone detector within the interactive voice response unit for receiving a reason for the call from the caregiver.

41. The method of collecting home health-care information as in claim 40 further comprising defining the reason for the call as being a notification of a starting time of the visit from the caregiver in giving care to the care recipient.

42. The method of collecting home health-care information as in claim 40 further comprising defining the reason for the call as being a notification of continuation of care from the caregiver in giving care to the care recipient notifying the organization that a cumulative time of the visit will exceed a predetermined time limit.

43. The method of collecting home health-care information as in claim 40 further comprising defining the reason for the call as being a log off from the caregiver notifying the organization of an end of the visit.

44. The method of collecting home health-care information as in claim 44 wherein the tone detector that determines a type of care given by the caregiver to the care recipient further comprises a recorder within the interactive voice response unit for receiving service information from the caregiver following the notification of log off by the caregiver.

45. The method of collecting home health-care information as in claim 44 further comprising a host retrieving the service information from the interactive voice response unit and compiling the service information into a healthcare claim.

46. The method of collecting home health-care information as in claim 45 further comprising a screen for retrieving and repairing the compiled healthcare claim.

47. The method of collecting home health-care information as in claim 46 wherein the screen for repairing the compiled healthcare claim further comprises a supervisor terminal that allows a supervisor to open the compiled healthcare claim through a terminal and listening to the recorded service information.
